(19) United States
(12) Patent Application Publication
(10) Pub. No.: US 2020/0090558 A1
(43) Pub. Date: Mar. 19, 2020

(54) T- Post Sign Attachment Apparatus

(71) Applicant: Glenn Hutchison, Gunnison, CO (US)

(72) Inventor: Glenn Hutchison, Gunnison, CO (US)

(21) Appl. No.: 16/134,718

(22) Filed: Sep. 18, 2018

(51) Int. Cl. G09F 7/18

(52) U.S. Cl. CPC G09F 7/18; G09F 2007/1817

(57) ABSTRACT

A t-post sign attachment apparatus for mounting a sign to a t-post includes a rectangular prismatic face plate having a post side, a back side, a top edge, and a bottom edge. A cap is coupled to the post side of the face plate adjacent the top edge. The cap comprises a vertical wall and a horizontal top side continuously disposed on an upper edge of the vertical wall. The cap is configured to rest on a standard t-post. A pair of hooks is coupled to the face plate adjacent the bottom edge and is configured to slidably engage with the standard t-post. A sign body coupled to the face plate, the sign body being coplanarly coupled to the top edge of the face plate.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to sign attachment systems and more particularly pertains to a new sign attachment system for mounting a sign to a t-post.

### BRIEF SUMMARY OF THE INVENTION

An embodiment of the disclosure meets the needs presented above by generally comprising a rectangular prismatic face plate having a post side, a back side, a top edge, and a bottom edge. A cap is coupled to the post side of the face plate adjacent the top edge. The cap comprises a vertical wall and a horizontal top side continuously disposed on an upper edge of the vertical wall. The cap is configured to rest on a standard t-post. A pair of hooks is coupled to the face plate adjacent the bottom edge and is configured to slidably engage with the standard t-post. A sign body coupled to the face plate, the sign body being coplanarly coupled to the top edge of the face plate.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a t-post sign attachment apparatus according to an embodiment of the disclosure.

FIG. 2 is an isometric view of an embodiment of the disclosure.

FIG. 3 is a side elevation view of an embodiment of the disclosure.

FIG. 4 is a bottom plan view of an embodiment of the disclosure.

FIG. 5 is a rear elevation view of an embodiment of the disclosure.

FIG. 6 is an in-use front elevation view of an embodiment of the disclosure.

### DETAILED DESCRIPTION OF THE INVENTION

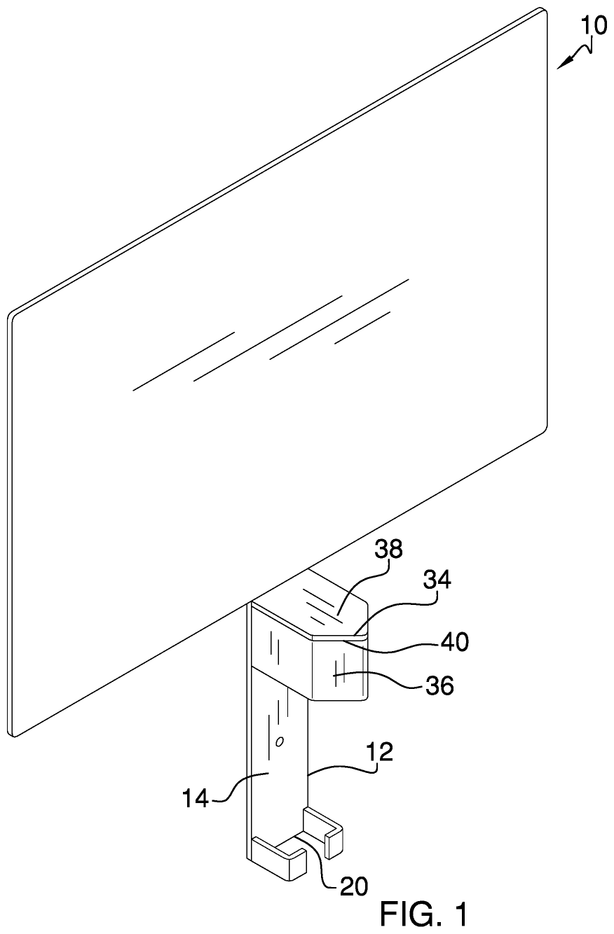

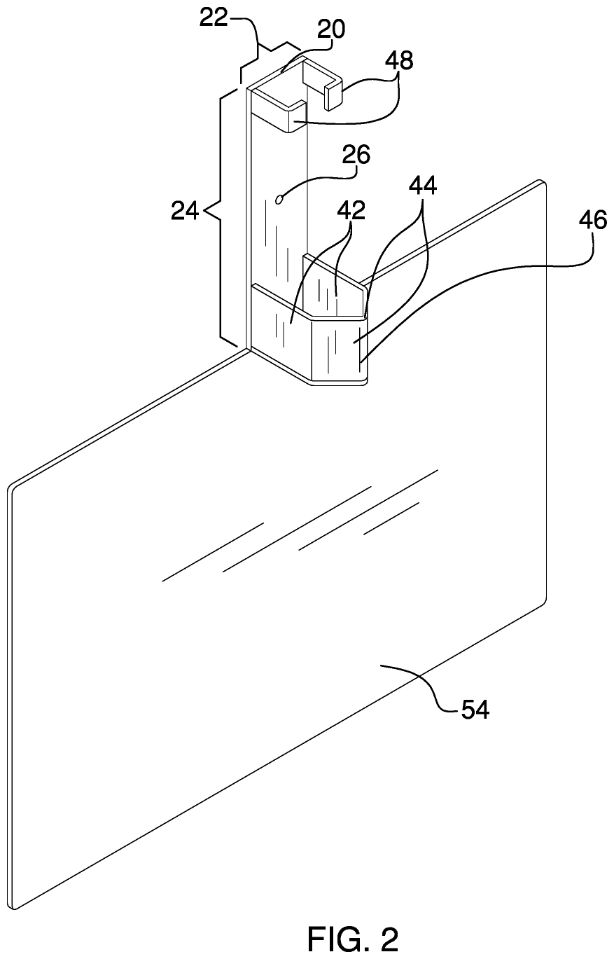

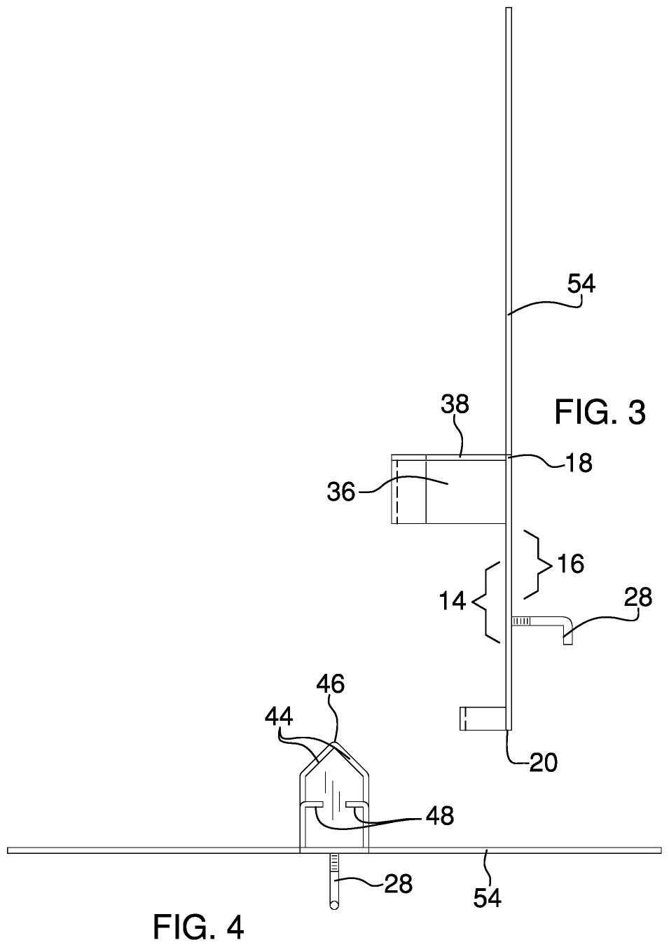

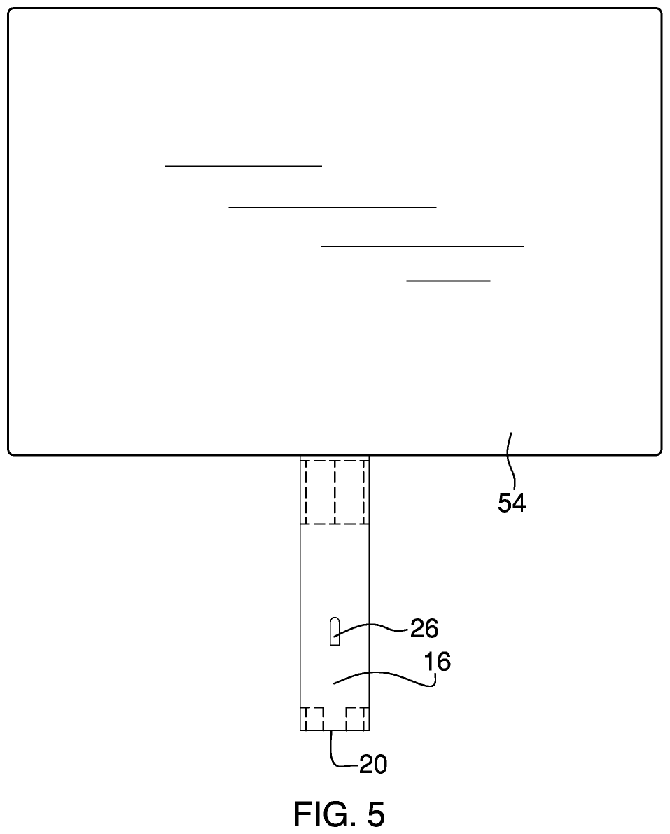

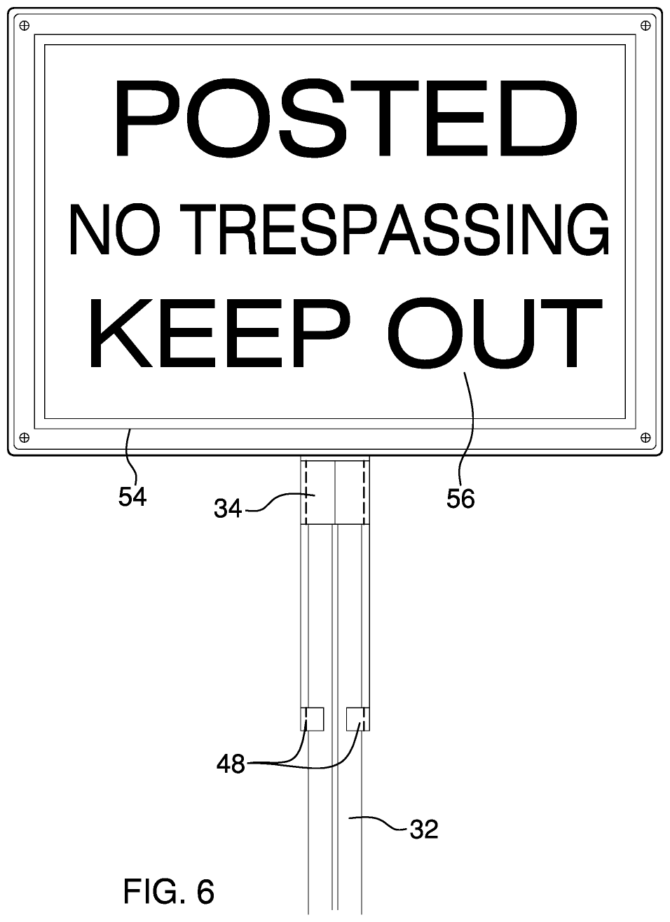

With reference now to the drawings, and in particular to FIGS. 1 through 6 thereof, a new sign attachment system embodying the principles and concepts of an embodiment of the disclosure and generally designated by the reference numeral 10 will be described.

As best illustrated in FIGS. 1 through 6, the t-post sign attachment apparatus 10 generally comprises a rectangular prismatic face plate 12 having a post side 14, a back side 16, a top edge 18, and a bottom edge 20. The face plate 12 may have a width 22 of at least 3.8 centimeters and a height 24 of at least 15.2 centimeters. The face plate 12 may have a mounting aperture 26 extending through the post side 14 to the back side 16 that is configured to receive a mounting bolt 28 that passes through a post aperture of a plurality of post apertures 30 of a standard t-post 32 to secure the t-post sign attachment apparatus 10 to the t-post 32. A cap 34 is coupled to the post side 14 of the face plate adjacent the top edge 18 and comprises a vertical wall 36 and a horizontal top side 38 continuously disposed on an upper edge 40 of the vertical wall. The vertical wall 36 of the cap comprises a pair of straight walls 42 and a pair of angled walls 44 with the pair of angled walls forming a point 46 creating a pentagonal shape with the face plate 12 configured to snugly receive the t-post 32. The point 46 may be at least 6.3 centimeters from the face plate 12. The cap 34 is configured to rest on the standard t-post 32. A pair of hooks 48 is coupled to the post side 14 of the face plate adjacent the bottom edge 20. Each of the pair of hooks 48 may have an extension portion 50 and a bent portion 52 with the bent portion perpendicular the extension portion 50. The extension portion 52 of each of the pair of hooks may extend at least 2.5 centimeters from the face plate 12. The pair of hooks 48 is configured to slidably engage with the standard t-post 32. A sign body 54 is coplanarly coupled to the top edge 18 of the face plate. The sign body 54 may display a message 56 such as “NO TRESPASSING”.

In use, the pair of hooks 48 are slid down the t-post 32 until the t-post rests within the cap 34. The mounting bolt 28 is then passed through the mounting bolt aperture 26 and a post aperture of the plurality of post apertures 30.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A t-post sign attachment apparatus comprising:
a rectangular prismatic face plate having a post side, a back side, a top edge, and a bottom edge;
a cap coupled to the face plate, the cap being coupled to the post side adjacent the top edge, the cap comprising a vertical wall and a horizontal top side continuously disposed on an upper edge of the vertical wall, the cap being configured to rest on a standard t-post;
a pair of hooks coupled to the face plate, the pair of hooks being coupled to the post side adjacent the bottom edge, the pair of hooks being configured to slidably engage with the standard t-post, each of the pair of hooks having an extension portion and a bent portion, the extension portion extending between the face plate and the bent portion, the bent portion extending perpendicularly from the extension portion wherein the bent portion is parallel to the face plate, the bent portions of the pair of hooks extending from the extension portion towards each other and terminating defining a gap therebetween; and
a sign body coupled to the face plate, the sign body being coplanarly coupled to the top edge of the face plate.

2. The t-post sign attachment apparatus of claim 1 further comprising the face plate having a mounting aperture extending through the post side to the back side, the mounting bolt aperture being configured to receive a mounting bolt engages the standard t-post to secure the t-post sign attachment apparatus to the t-post.

3. The t-post sign attachment apparatus of claim 1 further comprising the vertical wall of the cap comprising a pair of straight walls and a pair of angled walls, the pair of angled walls forming a point.

4. (canceled)

5. The t-post sign attachment apparatus of claim 1 further comprising the extension portion of each of the pair of hooks extending at least 2.5 centimeters from the face plate and the point of the vertical wall of the cap being at least 6.3 centimeters from the face plate, the face plate having a width of at least 3.8 centimeters and a height of at least 15.2 centimeters.

6. A t-post sign attachment apparatus comprising:
a rectangular prismatic face plate having a post side, a back side, a top edge, and a bottom edge, the face plate having a mounting aperture extending through the post side to the back side, the mounting bolt aperture being configured to receive a mounting bolt that engages a standard t-post to secure the t-post sign attachment apparatus to the t-post;
a cap coupled to the face plate, the cap being coupled to the post side adjacent the top edge, the cap comprising a vertical wall and a horizontal top side continuously disposed on an upper edge of the vertical wall, the vertical wall of the cap comprising a pair of straight walls and a pair of angled walls, the pair of angled walls forming a point, the cap being configured to rest on a standard t-post;
a pair of hooks coupled to the face plate, the pair of hooks being coupled to the post side adjacent the bottom edge, each of the pair of hooks having an extension portion and a bent portion, the extension portion extending between the face plate and the bent portion, the bent portion extending perpendicularly from the extension portion wherein the bent portion is parallel to the face plate, the bent portions of the pair of hooks extending from the extension portion towards each other and terminating defining a gap therebetween, the pair of hooks being configured to slidably engage with the standard t-post; and
a sign body coupled to the face plate, the sign body being coplanarly coupled to the top edge of the face plate.

7. A t-post and t-post sign attachment apparatus combination comprising:
a t-post,
a rectangular prismatic face plate having a post side, a back side, a top edge, and a bottom edge, the face plate having a mounting aperture extending through the post side to the back side, the mounting bolt aperture being configured to receive a mounting bolt that engages the t-post sign attachment apparatus to the t-post;
a cap coupled to the face plate, the cap being coupled to the post side adjacent the top edge, the cap comprising a vertical wall and a horizontal top side continuously disposed on an upper edge of the vertical wall, the vertical wall of the cap comprising a pair of straight walls and a pair of angled walls, the pair of angled walls forming a point, the cap resting on the t-post;
a pair of hooks coupled to the face plate, the pair of hooks being coupled to the post side adjacent the bottom edge, each of the pair of hooks having an extension portion and a bent portion, the extension portion extending between the face plate and the bent portion, the bent portion extending perpendicularly from the extension portion wherein the bent portion is parallel to the face plate, the bent portions of the pair of hooks extending from the extension portion towards each other and terminating defining a gap therebetween, the pair of hooks being slidably engageable with the t-post; and
a sign body coupled to the face plate, the sign body being coplanarly coupled to the top edge of the face plate.

8. The apparatus of claim 1, further comprising:
the face plate having a width of at least 3.8 centimeters and a height of at least 15.2 centimeters, the face plate having a mounting aperture extending through the post side to the back side, the mounting bolt aperture being configured to receive a mounting bolt that engages standard t-post to secure the t-post sign attachment apparatus to the t-post;
the vertical wall of the cap comprising a pair of straight walls and a pair of angled walls, the pair of angled walls forming a point, the point being at least 6.3 centimeters from the face plate; and
the extension portion of each of the pair of hooks extending at least 2.5 centimeters from the face plate.
